(19) United States
(12) Patent Application Publication
(10) Pub. No.: US 2011/0282740 A1
(43) Pub. Date: Nov. 17, 2011

(54) INFORMATION PROCESSING APPARATUS AND CONTROL METHOD THEREOF

(75) Inventors: Makoto Ochi, Osaka (JP); Takuji Maeda, Osaka (JP); Monta Nakatsuka, Osaka (JP); Kazuya Fujimura, Nara (JP); Seiji Nakazawa, Osaka (JP)

(73) Assignee: PANASONIC CORPORATION, Osaka (JP)

(21) Appl. No.: 13/146,255

(22) PCT Filed: Jun. 30, 2010
(86) PCT No.: PCT/JP2010/004302

§ 371 Date: Jul. 26, 2011

(30) Foreign Application Priority Data
Jul. 1, 2009 (JP) 2009-156696

(51) Int. Cl. G06Q 30/00; G06F 3/038

(52) U.S. Cl. 705/14.53; 705/14.4; 345/212

(57) ABSTRACT

To combine thrifty power consumption with up-to-dateness of displayed information, an information processing apparatus (100) includes: a battery unit (114); a remaining amount determining unit (113) which determines a remaining battery amount; a display unit (111) having a memory characteristic; a power-off determining unit (116) which specifies an amount of power to be supplied from the battery unit to the information processing apparatus that is equal to or less than a predetermined amount; a timer unit (115) which controls a start of supplying power at a predetermined time; and a control unit (110) which (i) causes the timer unit to set the predetermined time, and causes the amount of the power to be equal to or less than the predetermined amount, and (ii) displays, on the display unit, information about the remaining battery amount when the timer unit starts the supply of the power to the information processing apparatus.

### TECHNICAL FIELD

The present invention relates to a portable information processing apparatus which includes a display device having an electronic paper characteristic as a display function, and to a control method thereof.

### BACKGROUND ART

Conventionally, display devices including what is called liquid crystal displays have generally become widespread as display devices in various mobile information processing apparatuses such as personal computers, mobile phone terminals, smartphones, game terminals, audio players, and video players.

However, in recent years, some of the information processing apparatuses including display devices as what is called electronic papers have become widespread.

Non Patent Literature 1 defines an electronic paper as follows.

“A concept of a still-image-oriented electronic medium which is intended to substitute printed material, displays readable characters, and is generally realized by a display technique using reflection and having a memory characteristic”

Although it is necessary to supply power to the electronic paper when a display on a screen is updated, it is not necessary to supply power to the electronic paper once the display is updated. In other words, in comparison with a display device which requires constant power supply during displaying, like a liquid crystal display, the electronic paper allows low power consumption.

Examples of a specific device which implements the electronic paper include information processing apparatuses using a scheme such as a microcapsule electrophoretic display scheme and a cholesteric liquid crystal display scheme, and the information processing apparatuses, including other schemes, are used for various purposes (see Non Patent Literature 1, for instance).

Reducing power consumption of each function or device generally included in various mobile information processing apparatuses is essential to increase convenience. Using a device having an electronic paper function for the above display device is an effective means to low power consumption. For example, Patent Literature 1 discloses a technique relating to an information distribution system using an electronic paper.

[Citation List]

### [Patent Literature]

[Patent Literature 1]

Japanese Unexamined Patent Application Publication No. 2007-172207

### [Non Patent Literature]

[Non Patent Literature 1]

Denshi Zairyo Henshubu. “Denshi Zairyo 2008 Nen 5 Gatsu Go Bettusatsu Display Technique 2008”, Kogyo Chosakai Publishing Co., Ltd., 8 Apr., 2008: 55.

### SUMMARY OF INVENTION

### [Technical Problem]

In the case of a display technique having a memory characteristic such as an electronic paper, once a display on a screen is updated, it is not necessary to supply power to maintain the display. Thus, normally, after an information processing apparatus is powered off, the display on the electronic paper is not updated. Consequently, there is a case where contents displayed on the electronic paper are not up-to-date after the power is off. However, when the power is left on to always update a display, thrifty power consumption, an advantage of the electronic paper, cannot be used. Therefore, it has been difficult to combine the thrifty power consumption with up-to-dateness of display information.

In particular, Patent Literature 1 discloses a technique of displaying, on a display device, a remaining battery amount of an information processing apparatus. Unfortunately, leaving a battery attached to an apparatus for many hours generally reduces a remaining battery amount of the apparatus due to self-discharge or the like.

For this reason, even when a display device including an electronic paper displays that the remaining battery amount is sufficiently high, there is a case where the remaining battery amount of the apparatus is zero upon switching on the apparatus by a user.

To put it differently, conventional information processing apparatuses have difficulty displaying an accurate remaining battery amount while making use of the thrifty power consumption of the electronic paper. Furthermore, as a result, it has been difficult to implement a user interface which does not misunderstand the user or a user-friendly user interface.

In view of the above problems, the present invention has an object to provide an information processing apparatus which includes an electronic paper as a display device and updates a current screen display to an appropriate screen display as a display of a remaining battery amount in a period of time during which the apparatus is powered off, and an appropriate operation control method.

### [Solution to Problem]

An information processing apparatus according to an aspect of the present invention includes: a battery unit configured to supply power to the information processing apparatus; a remaining amount determining unit configured to determine a remaining battery amount held by the battery unit; a display unit having a memory characteristic for continuously holding a display content without power supply; a power-off determining unit configured to specify an amount of power to be supplied from the battery unit to the information processing apparatus that is equal to or less than a predetermined amount; a timer unit configured to control a start of supplying power from the battery unit to the information processing apparatus, at a predetermined time; and a control unit configured to (i) cause the timer unit to set the predetermined time based on the remaining battery amount determined by the remaining amount determining unit, and cause the amount of the power to be supplied from the battery unit to the information processing apparatus to be equal to or less than the predetermined amount, when the power-off determining unit specifies the amount of the power to be supplied from the battery unit to the information processing apparatus that is equal to or less than the predetermined amount, and (ii) display, on the display unit, information about the remaining battery amount, based on the remaining battery amount determined by the remaining amount determining unit, when the timer unit starts the supply of the power to the information processing apparatus.

With this configuration, powering the information processing apparatus on only with a timing at which the display on the display unit is updated allows the display of the remaining battery amount to be continuously updated.

Consequently, the information processing apparatus including the electronic paper as the display device makes it possible to combine thrifty power consumption with up-to-dateness of the display of the remaining battery amount. Furthermore, achieving appropriate screen display and screen update in a period of time during which the information processing apparatus is powered off makes it possible to provide a user interface which does not misunderstand a user or a user-friendly user interface.

Moreover, the information processing apparatus further includes a management table, wherein the control unit may obtain, from the management table, time information based on the remaining battery amount determined by the remaining amount determining unit, and cause the timer unit to set the predetermined time according to the time information.

With this configuration, it is possible to accurately know a time at which the display of the remaining battery amount should be updated next. Thus, it is possible to reduce the number of times the information processing apparatus is powered on despite there is no need to update the display of the remaining battery amount, thereby further enhancing the thrifty power consumption.

Furthermore, an information processing apparatus according to another aspect of the present invention may include: a display unit having a memory characteristic for continuously holding a display content without power supply; a power-off determining unit which specifies an amount of power to be supplied to the information processing apparatus that is equal to or less than a predetermined amount; and a control unit which displays predetermined data on the display unit and set the amount of the power to be supplied to the information processing apparatus to be equal to or less than the predetermined amount, when the power-off determining unit specifies the amount of the power supplied to the information processing apparatus that is equal to or less than the predetermined amount.

With this configuration, it is possible to display, on the display unit, information useful for a user, with a timing at which the information processing apparatus is powered off. As a result, in comparison with a case where the information processing apparatus is powered off without displaying anything, it is possible to display, on the display unit, up-to-date information while maintaining thrifty power consumption.

It is to be noted that the predetermined data may be data of the remaining battery amount displayed on the display unit that is updated to a predetermined display.

It is to be noted that the predetermined data may be advertisement data.

It is to be noted that the information processing apparatus may further include: a browsed information determining unit which accumulates and determines browsed information of a user; and an advertisement data accumulation unit which accumulates advertisement data, wherein the control unit may select the advertisement data accumulated in the advertisement data accumulation unit, based on a result of the determination, which is made by the browsed information determining unit, of the browsed information of the user according to a predetermined evaluation criterion.

With this configuration, the information processing apparatus makes it possible to determine, with reference to a browse history of the user, advertisement information to be displayed on the display unit at a timing with which the information processing apparatus is powered off. Consequently, it is possible to display, on the display unit, more up-to-date information suitable for preferences of the user while maintaining the thrifty power consumption.

Moreover, the information processing apparatus may further include: a server notifying unit which notifies a server of information via a communication network, wherein the control unit may notify, through the server notifying unit, the server of information uniquely specifying the predetermined data displayed on the display unit, when the power-off determining unit specifies the amount of the power to be supplied to the information processing apparatus that is equal to or less than the predetermined amount.

With this configuration, the server makes it possible to tally, in an integrated fashion, the information displayed on the information processing apparatus. Accordingly, it is possible to display more up-to-date information on the display unit based on the result of tally.

Moreover, the information processing apparatus may further include an elapsed time calculating unit which calculates a period of time during which power is not supplied, from a difference between a display at the time when power is supplied to the display unit and a display at the time when power is not supplied to the display unit, wherein the control unit may notify, through the server notifying unit, the server of a period of time during which power is not supplied and which is determined by a display time determining unit.

It is to be noted that predetermined evaluation criterion may be a value based on a total browsing time of the user.

It is to be noted that the browsed information determining unit may make the determination based on the information displayed on the display unit, and the control unit may select the advertisement data accumulated in the advertisement data accumulation unit, based on the result of the determination.

It is to be noted that the predetermined data may be information indicating whether or not the user has used or browsed various types of content stored in the information processing apparatus.

It is to be noted that the predetermined data may be an information list of various types of content data stored in the information processing apparatus.

It is to be noted that the predetermined data may be data for erasing part or all of data displayed on said display unit.

Furthermore, it goes without saying that the present invention may be realized as not only the information processing apparatus but also a control method of the information processing apparatus.

### ADVANTAGEOUS EFFECTS OF INVENTION

The information processing apparatus makes it possible to provide the user interface which does not misunderstand the user or the user-friendly user interface, by achieving appropriate screen display and screen update in the period of time during which the information processing apparatus is powered off.

In addition, the information processing apparatus including the electronic paper as the display device makes it possible to combine the thrifty power consumption with the up-to-dateness of the display of the remaining battery amount.

### BRIEF DESCRIPTION OF DRAWINGS

[FIG. 1]

FIG. 1 is a block diagram showing a configuration of an information processing apparatus according to Embodiment 1 of the present invention.

[FIG. 2]

FIG. 2 is an external view of the information processing apparatus according to Embodiment 1 of the present invention.

[FIG. 3]

FIG. 3 is a diagram showing a data structure of data managed in a management table according to Embodiment 1 of the present invention.

[FIG. 4]

FIG. 4 is a flowchart showing a flow of display update control processing when the information processing apparatus according to Embodiment 1 of the present invention is powered off.

[FIG. 5]

FIG. 5 is a flowchart showing a flow of processing after elapse of a time set by a timer of the information processing apparatus according to Embodiment 1 of the present invention.

[FIG. 6]

FIG. 6 is a first external view illustrating update of a display of a remaining battery amount of the information processing apparatus according to Embodiment 1 of the present invention.

[FIG. 7]

FIG. 7 is a second external view illustrating update of a display of a remaining battery amount of the information processing apparatus according to Embodiment 1 of the present invention.

[FIG. 8]

FIG. 8 is a block diagram showing a configuration of an information processing apparatus according to Embodiment 2 of the present invention.

[FIG. 9]

FIG. 9 is an external view illustrating an example of a screen layout at the time of handling news information as contents handled by the information processing apparatus according to Embodiment 2 of the present invention.

[FIG. 10]

FIG. 10 is a diagram showing an example of a data structure of browsed information managed by a browsed information determining unit according to Embodiment 2 of the present invention.

[FIG. 11]

FIG. 11 is a flowchart showing a sequence of display update control processing when the information processing apparatus according to Embodiment 2 of the present invention is powered off.

[FIG. 12]

FIG. 12 is an external view showing an example of advertisement data displayed on the information processing apparatus according to Embodiment 2 of the present invention.

[FIG. 13]

FIG. 13 is an external view showing an example of browse result of news information by a user which is displayed on the information processing apparatus according to Embodiment 2 of the present invention.

[FIG. 14]

FIG. 14 is an external view showing an example of a news digest displayed on the information processing apparatus according to Embodiment 2 of the present invention.

[FIG. 15]

FIG. 15 is a diagram illustrating a configuration of a server cooperation system according to Embodiment 3 of the present invention.

[FIG. 16]

FIG. 16 is a block diagram showing a configuration of an information processing apparatus according to Embodiment 3 of the present invention.

[FIG. 17]

FIG. 17 is a flowchart showing a flow of processing for controlling update of a display on a display unit and server notification control processing when the information processing apparatus according to Embodiment 3 of the present invention is powered off.

[FIG. 18]

FIG. 18 is a flowchart showing a flow of processing by a server notifying unit 1601 at the time when the information processing apparatus according to Embodiment 3 of the present invention is powered on.

[FIG. 19]

FIG. 19 is a block diagram showing a configuration of an information processing apparatus according to Embodiment 4 of the present invention.

[FIG. 20]

FIG. 20 is a diagram showing a specific structure of an electrophoretic electronic paper of a display unit included in the information processing apparatus according to Embodiment 4 of the present invention.

[FIG. 21]

FIG. 21 is a diagram showing a relationship between elapse of a time of a display unit and a ratio of a current charge amount to an initial charge amount according to Embodiment 4 of the present invention.

[FIG. 22]

FIG. 22 is a flowchart showing a flow of display update control processing of a display unit, server notification control processing, and elapsed time calculation control processing when the information processing apparatus according to Embodiment 4 of the present invention is powered off.

[FIG. 23]

FIG. 23 is a flowchart showing a flow of processing by a server notifying unit 1601 at the time when the information processing apparatus according to Embodiment 4 of the present invention is powered on.

[FIG. 24]

FIG. 24 is an external view showing an example of a computer system implementing the information processing apparatus according to Embodiments 1 to 4 of the present invention.

[FIG. 25]

FIG. 25 is a block diagram showing a hardware configuration of the computer system implementing the information processing apparatus according to Embodiments 1 to 4 of the present invention.

### DESCRIPTION OF EMBODIMENTS

### Embodiment 1

The following describes Embodiment 1 of the present invention based on the drawings.

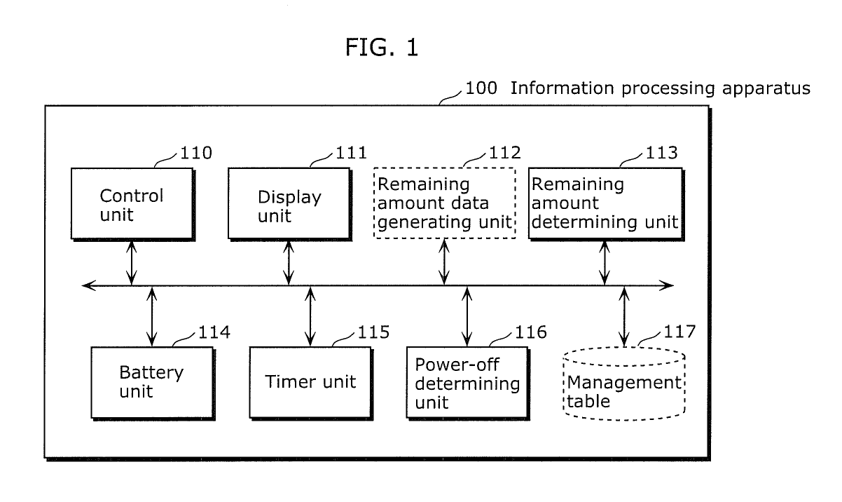

FIG. 1 is a block diagram showing a configuration of an information processing apparatus according to this embodiment of the present invention. An information processing apparatus 100 includes a control unit 110, a display unit 111, a remaining amount data generating unit 112, a remaining amount determining unit 113, a battery unit 114, a timer unit 115, a power-off determining unit 116, and a management table 117.

A mobile digital apparatus such as a mobile telephone terminal, an electronic dictionary, and an electronic book reader is assumed as the information processing apparatus 100.

The control unit 110 controls various operations in the information processing apparatus, and is a hardware circuit or a software module which controls various operations of the display unit 111, the remaining amount data generating unit 112, the remaining amount determining unit 113, the battery unit 114, the timer unit 115, the power-off determining unit 116, and the management table 117.

The display unit 111 is an electronic paper display which displays various types of information. In other words, the display unit 111 has a memory characteristic that power supply from the battery unit 114 is necessary when displayed information is updated, but the power supply from the battery unit 114 is not necessary once information is updated.

The electronic paper device is a device using a scheme such as a microcapsule electrophoretic display scheme and a cholesteric liquid crystal display scheme. A description of a detailed configuration of the electronic paper device is omitted here.

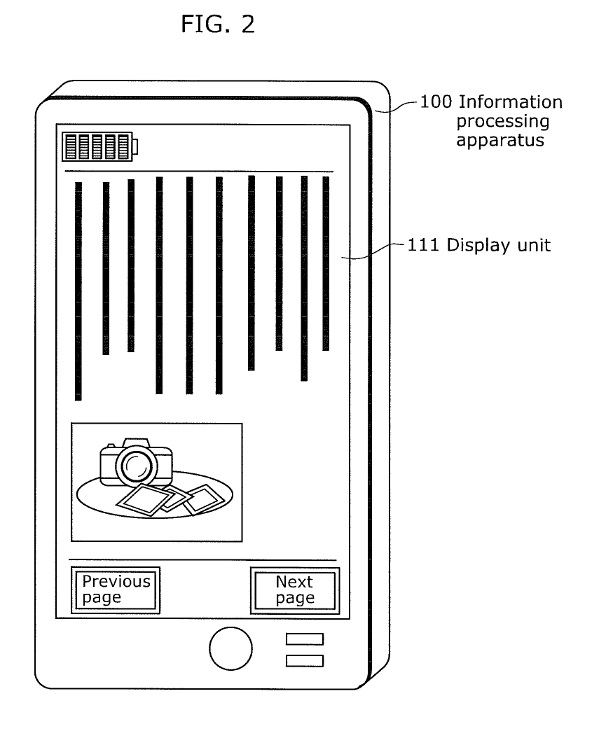

The remaining amount data generating unit 112 generates data for indicating a remaining battery amount on the display unit 111. FIG. 2 shows an external configuration example of the information processing apparatus 100. As shown in FIG. 2, the remaining amount data generating unit 112 is a software module which creates an image indicating a remaining battery amount on a left top corner.

The remaining amount determining unit 113 is a hardware circuit or a software module which determines the remaining battery amount (discharged capacity) of the battery unit 114.

The battery unit 114 is a primary battery or a rechargeable battery which supplies power to each module in the information processing apparatus 100.

The timer unit 115 has a clock function, and is a hardware circuit or a software module which functions as a timer. Though not specifically shown, after elapse of a predetermined time set in the timer, the timer unit 115 powers the information processing apparatus 100 on, that is, starts power supply from the information processing apparatus 100 to the control unit 110.

The power-off determining unit 116 is a hardware circuit or a software module which determines whether or not the information processing apparatus 100 is to be powered off.

The management table 117 holds a table having information indicating, with respect to the remaining battery amount (discharged capacity) determined by the remaining amount determining unit 113, for how long the information processing apparatus 100 can operate until the information processing apparatus 100 runs out of the battery when the information processing apparatus 100 is left on and when the information processing apparatus 100 is left off.

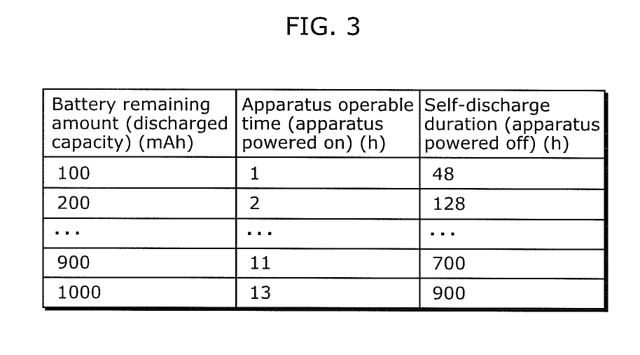

FIG. 3 shows a data structure of the management table 117. For instance, as shown in FIG. 3, when the remaining battery amount is 900 mAh, the information processing apparatus 100 has the operable time of 11 hours when the information processing apparatus 100 is left on, and the information processing apparatus 100 has the operable time (i.e., self-discharge time) of 700 hours when the information processing apparatus 100 is left off.

In this manner, the management table 117 holds detailed relevant data about the remaining battery amount and the operable time of the apparatus.

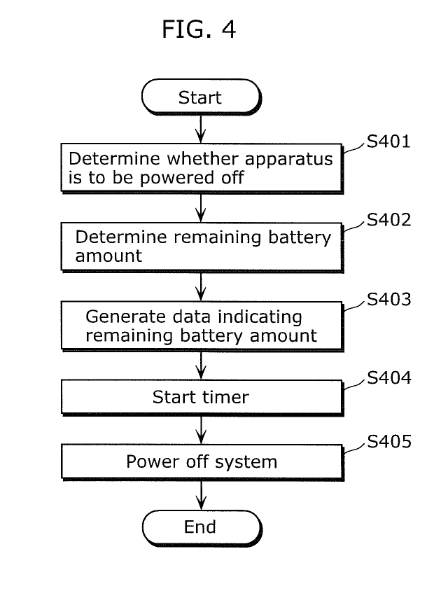

The following describes update control of a screen display when the information processing apparatus 100 is powered off, with reference to a flowchart. FIG. 4 is a flowchart showing a flow of display update control processing when the information processing apparatus 100 is powered off.

(Step S401) The power-off determining unit 116 determines whether or not the information processing apparatus 100 is to be powered off, based on a situation where a user has set a power switch of the information processing apparatus 100 to off or where the user has not operated the information processing apparatus 100 for a predetermined time.

(Step S402) Next, the control unit 110 obtains a remaining battery amount from the remaining amount determining unit 113. The control unit 110 obtains, with reference to the management table 117, information indicating for how long a battery lasts based on the obtained remaining battery amount.

(Step S403) Then, the control unit 110 provides, to the remaining amount data generating unit 112, the remaining battery amount obtained in Step S402 or endurance of the battery, and generates data indicating the remaining battery amount. The control unit 110 displays the generated data on the display unit 111.

(Step S404) Next, the control unit 110 starts the timer of the timer unit 115. Here, a set value (a time until next time the information processing apparatus 100 is powered on) of the timer started is changed according to the remaining battery amount displayed on the display unit 111.

For instance, as shown in FIG. 2, when the remaining battery amount is displayed using a five-level display, the control unit 110 calculates how long the endurance is when a current remaining battery amount is reduced by an amount indicated by one level, and sets the timer. More specifically, when the control unit 110 determines that the current remaining battery amount is 1000 mAh and the endurance until the five-level display is reduced by the one level is 200 hours, the control unit 110 sets the timer to 200 hours.

(Step S405) Then, the control unit 110 powers off the information processing apparatus 100. Here, powering off the information processing apparatus 100 means a process of suspending power supply from the battery unit 114 to processing units achieving various functions of the information processing apparatus 100. It is to be noted that the timer unit 115 is not suspended, and the power supply is continued.

Through the above processing, the control unit 110 displays, on the display unit 111 in the information processing apparatus 100, the remaining battery amount in a period of time during which a system is powered off, and then powers off the information processing apparatus 100.

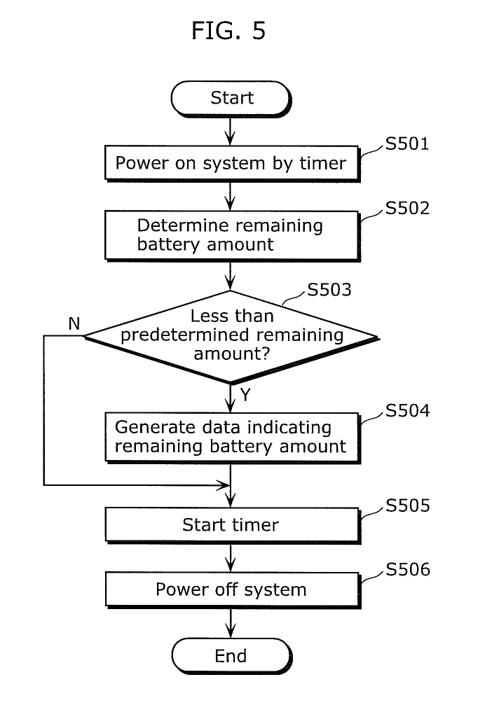

The following describes an operation processing sequence of the information processing apparatus 100 after elapse of a predetermined time set to the timer unit 115, with reference to FIG. 5.

(Step S501) After elapse of a set predetermined time, the timer unit 115 powers on and starts the information processing apparatus 100. Here, the timer unit 115 does not start all of the functions of the information processing apparatus, but may start only functions for performing minimum operations.

(Step S502) Next, the control unit 110 obtains a remaining battery amount from the remaining amount determining unit 113. Then, the control unit 110 obtains, with reference to the management table 117, information indicating for how long a battery lasts based on the obtained remaining battery amount.

(Step S503) Next, the control unit 110 determines whether or not it is necessary to update a displayed remaining battery amount, using the remaining battery amount displayed on the display unit 111 and a current remaining battery amount obtained from the remaining amount determining unit 113. When it is necessary to update a display of the remaining battery amount, the control unit 110 performs a process in Step S504. In contrast, when it is not necessary to update a display of the remaining battery amount, the control unit 110 performs a process in Step S505.

More specifically, for example, when a remaining battery amount is displayed on the display unit 111 using the five-level display as shown in FIG. 2 and when a remaining battery amount at the time of full charge is 1000 mAh as shown in FIG. 3, the remaining battery amount displayed on the display unit 111 is reduced by one level each time the remaining battery amount is reduced by 200 mAh.

In other words, when the remaining battery amount of the battery unit 114 is 0 mAh, more than 0 mAh and less than 200 mAh, at least 200 mAh and less than 400 mAh, at least 400 mAh and less than 600 mAh, at least 600 mAh and less than 800 mAh, and at least 800 mAh and less than 1000 mAh, the remaining battery amount is displayed on the display unit 111 using a corresponding display of one of 0 to 5 levels.

Thus, the control unit 110 determines whether or not a remaining battery level displayed on the display unit 111 based on the remaining battery amount obtained from the remaining amount determining unit 113 is different from a remaining battery level currently displayed on the display unit 111.

(Step S504) The control unit 110 provides the remaining battery amount or the battery endurance to the remaining amount data generating unit 112, and generates display data for displaying the remaining battery amount on the display unit 111 accordingly. The generated data is displayed on the display unit 111.

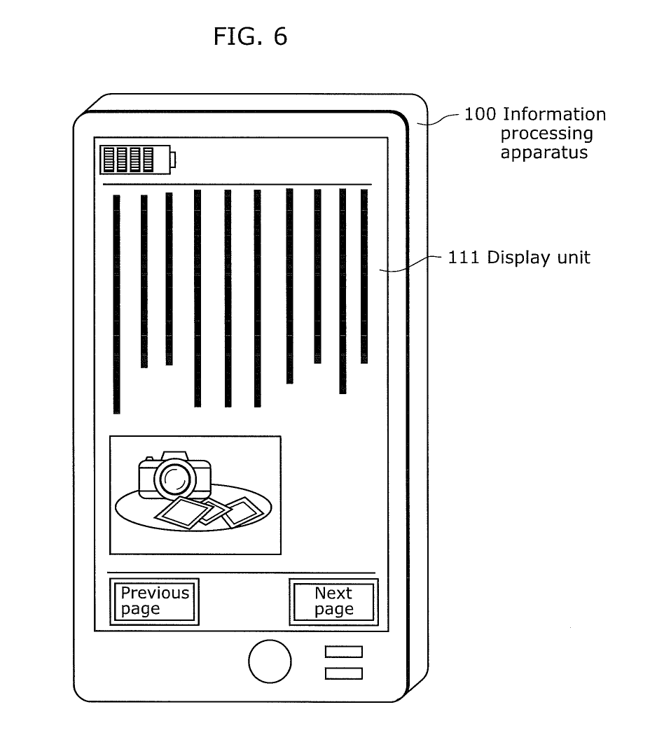

FIG. 6 is a diagram showing an example of a display of a remaining battery amount updated by the control unit 110. This display example is the same as the display of the remaining battery amount shown in FIG. 2 except that the remaining battery amount has been reduced by one level.

(Step S505) Then, the control unit 110 sets a next start time to the timer unit 115, and starts the timer. Here, the control unit 110 sets a set value of the timer according to the remaining battery amount.

(Step S506) Next, the control unit 110 powers off the information processing apparatus 100. A process of powering off here is the same process shown in Step S405.

As described above, even after the information processing apparatus 100 is powered off, the control unit 110 restarts the information processing apparatus 100 according to the remaining battery amount and updates the display of the remaining battery amount on the screen, thereby always displaying a correct display of the remaining battery amount.

The above processing enables the apparatus including the display device having the electronic paper characteristic to always maintain the correct display of only the remaining battery amount without loss of the thrifty power consumption of the electronic paper. In other words, the information processing apparatus including the electronic paper as the display device makes it possible to combine thrifty power consumption with up-to-dateness of display information.

Furthermore, it is possible to avoid a situation where there is no remaining battery amount when the user powers on the apparatus, thereby enhancing the user-friendliness of the apparatus.

It is to be noted that although this embodiment of the present invention has described the configuration of the information processing apparatus 100, the present invention is absolutely not limited to this embodiment. The embodiment can be modified without departing from a scope of the present invention. For instance, the present invention includes the following cases (modifications).

(1) The above embodiment has described the example where the control unit 110 sets the timer time of the timer unit 115 according to the remaining battery amount, but the control unit 110 may set the timer to a predetermined value (e.g., day by day) regardless of the remaining battery amount. In this case, at each predetermined time, the control unit 110 obtains the remaining battery amount from the remaining amount determining unit 113, and updates the display of the remaining battery amount on the display unit 111.

(2) The embodiment has described the example where the information processing apparatus 100 displays, on the display unit 111, the display of the remaining battery amount updated according to the remaining battery amount after the user powers off the information processing apparatus 100. However, as long as a method for displaying a remaining battery amount as a display of a remaining battery amount after the information processing apparatus 100 is powered off does not misunderstand the user, such a method may be any method for displaying.

For example, a display that shows how long the remaining battery amount would last may be displayed on the display unit 111 immediately before the information processing apparatus 100 is powered off.

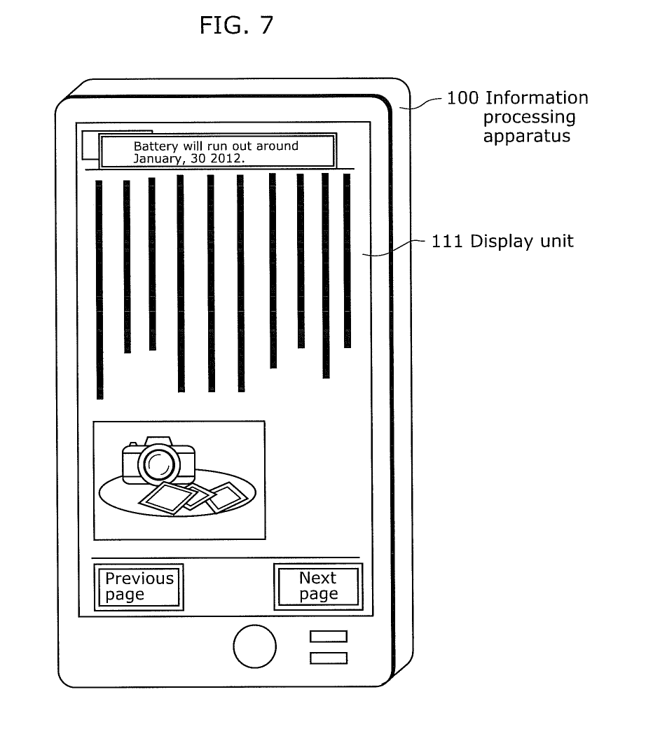

FIG. 7 shows a display example of the display unit 111 in such a case.

As shown in FIG. 7, a display that the remaining battery amount will run out around Jan. 30, 2012 is displayed on the display unit 111. To put it differently, the information processing apparatus 100 may display, on the display unit 111, information indicating a time when a remaining battery amount becomes less than a predetermined value, using not a relative display showing an elapsed time from a current time but absolute time information (e.g., a display by a calendar).

Moreover, though not shown, the information processing apparatus 100 may display, on the display unit 111, information indicating a date when the information processing apparatus 100 was powered off and endurance of the remaining battery amount (a time indicating how long the battery lasts) at that time.

It is to be noted that the information processing apparatus 100 according to this embodiment may not include the remaining amount data generating unit 112. In this case, for instance, the display unit 111 stores in advance several display patterns and the control unit 110 provides, to the display unit 111, a signal identifying a type of a display pattern, thereby producing the same effect as in the case where the remaining amount data generating unit 112 is included.

Furthermore, the information processing apparatus 100 according to this embodiment may not include the management table 117. In this case, for example, as described above, it is considered that the control unit 110 sets the timer to the predetermined value regardless of the remaining battery amount. As a result, at each predetermined time, the control unit 110 obtains a remaining battery amount from the remaining amount determining unit 113 and updates the display of the remaining battery amount on the display unit 111, thereby producing the same effect as in the case where the management table 117 is included.

### Embodiment 2

The following describes in detail Embodiment 2 of the present invention based on the drawings.

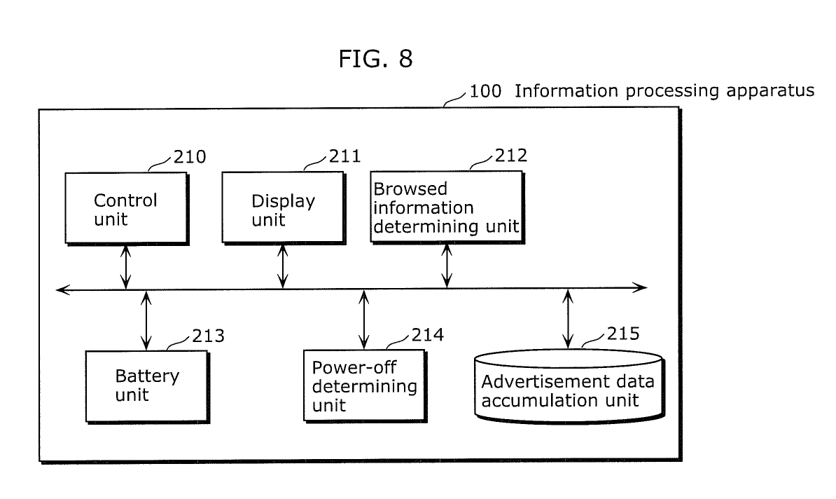

FIG. 8 is a block diagram showing a configuration of an information processing apparatus 100 according to this embodiment of the present invention. The information processing apparatus 100 includes a control unit 210, a display unit 211, a browsed information determining unit 212, a battery unit 213, a power-off determining unit 214, and an advertisement data accumulation unit 215.

The information processing apparatus 100 is a mobile digital apparatus such as mobile telephone terminal, an electronic dictionary, and an electronic book reader.

The control unit 210 controls various operations in the information processing apparatus 100, and controls various operations of the display unit 211, the browsed information determining unit 212, the battery unit 213, and the power-off determining unit 214.

A configuration of the display unit 211 is the same as in Embodiment 1, and thus a detailed description thereof is omitted.

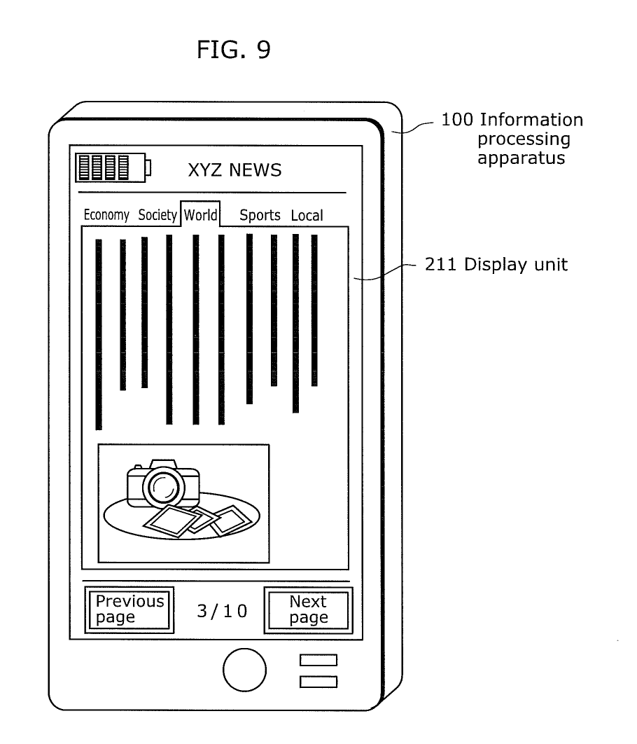

The browsed information determining unit 212 is a software module which accumulates and determines information browsed by a user. FIG. 9 shows a screen layout example in a case where news information is handled as contents by the information processing apparatus 100.

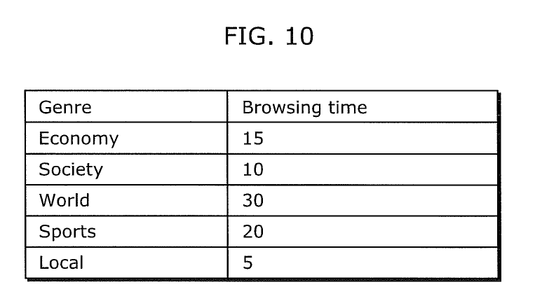

In FIG. 9, the information processing apparatus 100 displays world news items among news items of each genre (economy, society, world, sports, and local). In the case of the information processing apparatus 100 handling such news, for example, as shown in FIG. 10, the browsed information determining unit 212 manages a browsing time of each genre by the user. In the case of browsed information as shown in FIG. 10, it is clear that the user browsed, among news items, world news items for the longest time.

Configurations of the battery unit 213 and the power-off determining unit 214 are the same as in Embodiment 1, and thus a detailed description thereof is omitted.

The advertisement data accumulation unit 215 accumulates various types of advertisement data to be displayed on the display unit 211.

The following describes, with reference to a flowchart, display update control in a period of time during which the information processing apparatus 100 according to this embodiment is powered off.

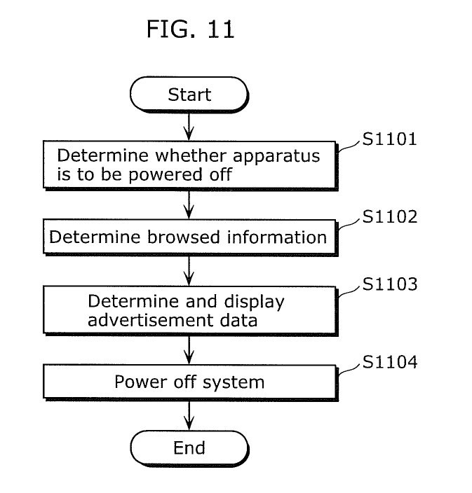

FIG. 11 is a flowchart showing a sequence of display update control processing when the information processing apparatus 100 is powered off.

(Step S1101) The power-off determining unit 214 determines whether or not the information processing apparatus 100 is to be powered off, based on a situation where a user has set a power switch of the information processing apparatus 100 to off or where the user has not operated the information processing apparatus 100 for a predetermined time.

(Step S1102) Next, the control unit 210 obtains, from the browsed information determining unit 212, a result of determination of browsed information of the user. For instance, in the case of handling news contents, the control unit 210 obtains a genre determined as news items having the longest browsing time among news items of each genre.

(Step S1103) Then, the control unit 210 selects, from the advertisement data accumulation unit 215, advertisement data to be displayed on the display unit 111, based on the information obtained in Step S1102. For example, in the case of handling the news contents, the control unit 210 selects advertisement data relevant to the obtained genre, and displays the selected advertisement data on the display unit 211.

(Step S1104) Next, the control unit 210 powers off the information processing apparatus 100.

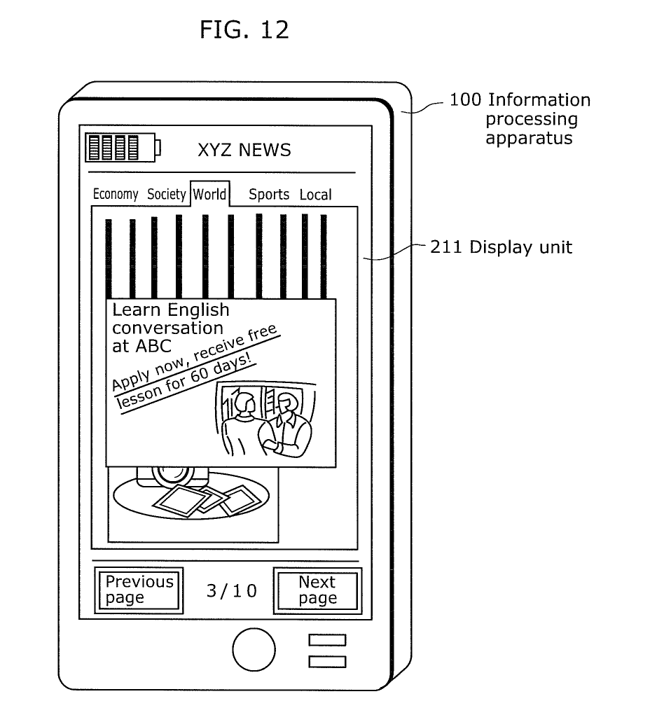

FIG. 12 is a diagram showing an example of advertisement data displayed by the information processing apparatus 100 through the above processing. For instance, as shown in FIG. 10, when, among the news items of each genre, the world news items have the longest browsing time, advertisement data on English conversation classes which is associated in advance with an advertisement relevant to the world news items is selected and displayed.

As described above, appropriately selecting information to be displayed on the display unit 211 in the period of time during which the information processing apparatus 100 including the display unit 211 having the electronic paper characteristic is powered off makes it possible to effectively display the information useful for the user even in the period of time during which the information processing apparatus 100 is powered off. As described in this embodiment, for example, displaying the advertisement information according to a browse history allows the information processing apparatus 100 to be a particularly effective means as a method for effectively sharing information for both the user and an advertisement data provider.

It is to be noted that although this embodiment has described the configuration of the information processing apparatus 100, the present invention is absolutely not limited to this embodiment. The embodiment can be modified without departing from a scope of the present invention. For instance, the present invention includes the following cases (modifications).

(1) The above embodiment has described the example where the advertisement data to be displayed on the display unit 211 is selected according to the length of the browsing time, but the selection is not limited to the above condition.

The control unit 210 may select advertisement data to be displayed on the display unit 211 in a period of time during which the information processing apparatus 100 is powered off, according to the number of browses, information previously browsed, and so on. Furthermore, even when order of priority is predetermined for advertisement data to be displayed, the advertisement data to be displayed may be randomly selected. Stated differently, any method which is a method for displaying information on a display unit in a period of time during which the information processing apparatus 100 is powered off may be employed.

(2) The embodiment has described the example where the advertisement data is displayed on the display unit 211, but data displayed on the display unit 211 may not be the advertisement data.

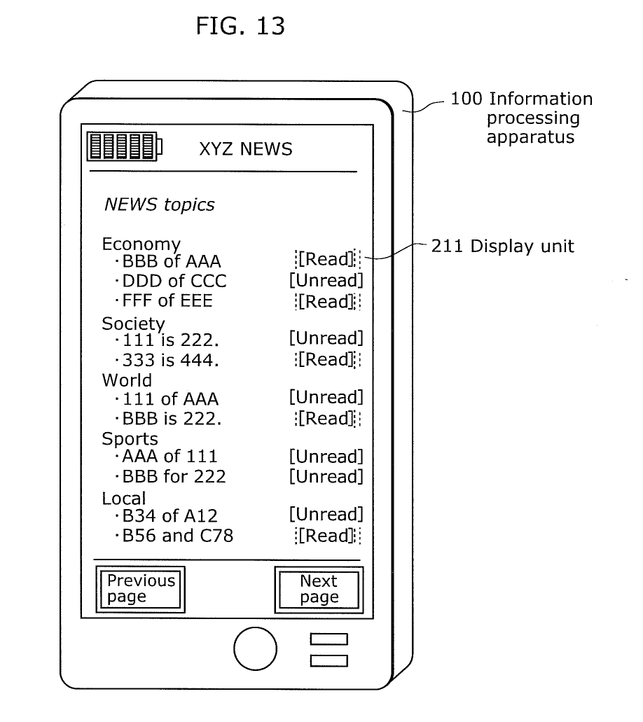

When the information processing apparatus 100 handles news items, for instance, as shown in FIG. 13, information indicating a result of browsing the news items by a user may be displayed on the display unit 211.

FIG. 13 shows an example where a display of “Read” or “Unread” indicates, for each topic of a corresponding one of the genres (economy, society, world, sports, and local), whether or not the user has browsed.

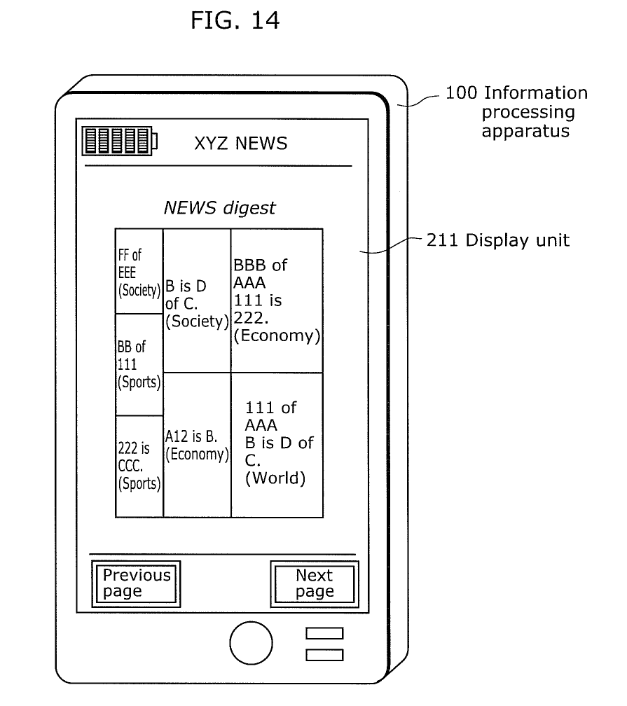

Moreover, as shown in FIG. 14, a digest display relating to news items may be created and displayed on the display unit 211.

In FIG. 14, an example of the digest display is shown by a display method for displaying information having a higher degree of importance in a larger window and information having a lower degree of importance in a smaller window.

As in these examples, information indicating whether or not the user has browsed, information organizing stored contents, information indicating how much the user has browsed, and so on may be displayed on the display unit 211. In other words, the information processing apparatus 100 may be any apparatus which is powered off while displaying, in the period of time of the power-off, various types of information on the display unit 211 having the electronic paper characteristic.

With the above, the information processing apparatus 100 according to the embodiment makes it possible to cut power consumption and display, on the display unit 211, the information useful for the user and so on.

(3) The embodiment has described the example where the information processing apparatus 100 displays the advertisement information while being powered off, but, as described in Embodiment 1, the information processing apparatus 100 may include the timer unit.

More specifically, when a predetermined time has elapsed since the information processing apparatus 100 was powered off, the timer unit may power on the information processing apparatus 100, the control unit 210 may determine whether or not the information displayed on the display unit 111 is to be updated, and update, based on a result of the determination, the displayed information as necessary.

(4) The embodiment has described the example where the information processing apparatus 100 displays the advertisement information while being powered off, but, in order to prevent information leakage from the information processing apparatus 100, a display on the display unit 211 may be deleted when the information processing apparatus 100 is powered off.

(5) The embodiment has described the example where various types of advertisement data are accumulated in the advertisement data accumulation unit 215 of the information processing apparatus 100, but the number of the types is not limited. The advertisement data accumulation unit 215 may include a nonvolatile recording medium in which many pieces of advertisement information are accumulated or a volatile recording medium in which only about one type of advertisement data is accumulated.

As long as the information processing apparatus 100 is configured to display, on the display unit 211, the advertisement data stored through a predetermined procedure in the information processing apparatus 100, in a period of time during which the information processing apparatus 100 is powered off, any method for displaying the advertisement data regardless of the number of pieces of advertisement information accumulated in the information processing apparatus 100, a type of a recording medium, a timing with which the advertisement data is obtained may be employed.

### Embodiment 3

The following describes in detail Embodiment 3 of the present invention based on the drawings.

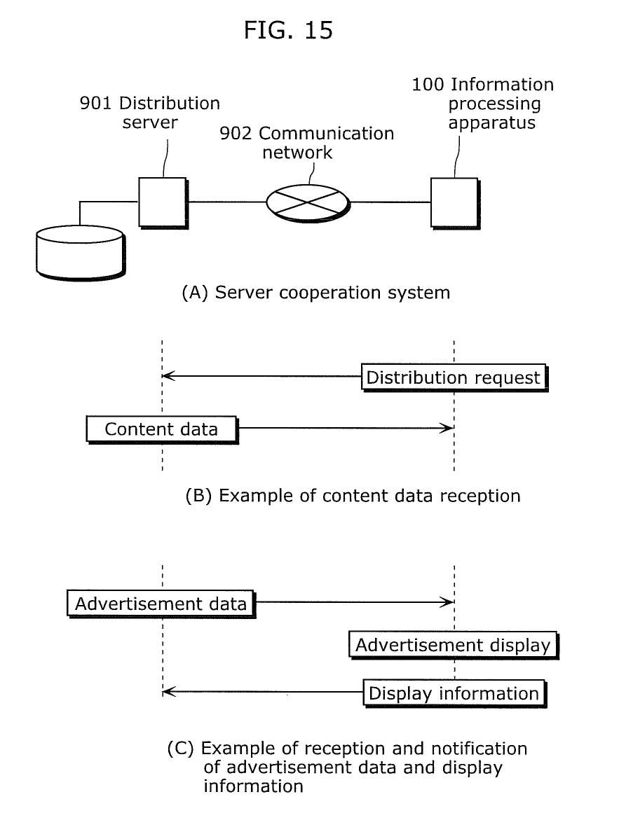

(A) in FIG. 15 is a schematic diagram showing a summary of a server cooperation system between the information processing apparatus 100 and a distribution server 901 according to this embodiment of the present invention.

The distribution server 901 distributes various types of data such as contents data to the information processing apparatus 100 through various types of a communication network 902 such as an Internet network and a broadcasting network.

For instance, as shown by a sequence diagram of (B) in FIG. 15, in response to a distribution request from the information processing apparatus 100 to the distribution server 901, the distribution server 901 distributes contents data such as book data to the information processing apparatus 100.

Furthermore, for example, advertisement data is received by the information processing apparatus 100 or display information is notified to the distribution server 901 in the manner shown by a sequence diagram of (C) in FIG. 15. In other words, when the distribution server 901 distributes the advertisement data to the information processing apparatus 100, the information processing apparatus 100 displays the distributed advertisement data. Then, the information processing apparatus 100 notifies the distribution server 901 of display information (information indicating what kind of advertisement data is displayed) of the displayed advertisement data.

The information processing apparatus 100 according to this embodiment is a system which cooperates with the distribution server 901 in the above manner. The following describes in more detail the information processing apparatus 100.

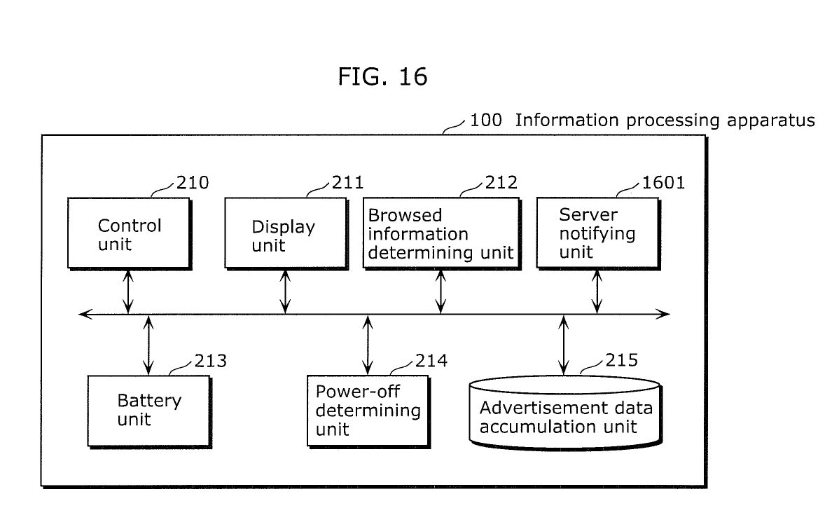

FIG. 16 is a block diagram showing a configuration of the information processing apparatus 100. The information processing apparatus 100 includes a control unit 210, a display unit 211, a browsed information determining unit 212, a battery unit 213, a power-off determining unit 214, an advertisement data accumulation unit 215, and a server notifying unit 1601.

A mobile digital apparatus such as a mobile telephone terminal, an electronic dictionary, and an electronic book reader is assumed as the information processing apparatus 100.

The control unit 210 controls various operations in the information processing apparatus 100, and controls various operations of the display unit 211, the browsed information determining unit 212, the battery unit 213, the power-off determining unit 214, and the server notifying unit 1601.

Configurations of the display unit 211, the browsed information determining unit 212, the battery unit 213, and the power-off determining unit 214 are the same as in Embodiment 1, and thus a detailed description thereof is omitted.

The server notifying unit 1601 notifies a server of information displayed on the display unit 211 (performs a server notification function). More specifically, the server notifying unit 1601 notifies, through a wired or wireless communication network, the distribution server 901 of what kind of data has been displayed on the display unit 211 having the memory characteristic while power is not supplied.

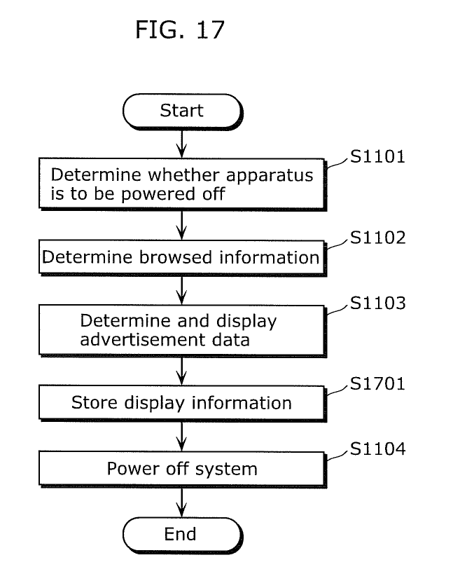

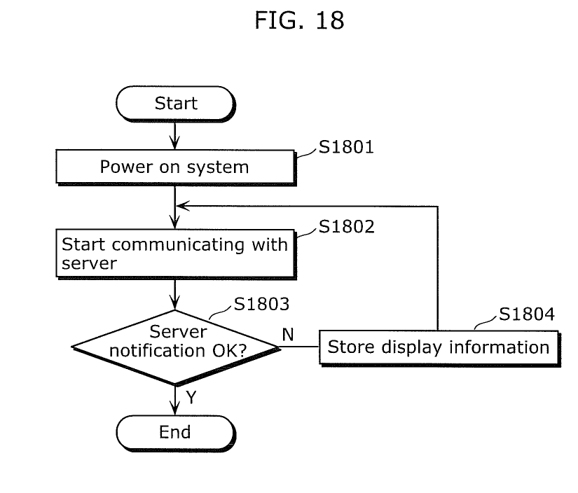

The following describes the server notification function with reference to FIGS. 17 and 18. FIG. 17 is a flowchart showing a flow of processing for controlling update of a display on the display unit 211 and server notification control processing for the distribution server 901 when the information processing apparatus 100 is powered off.

In the processing sequence shown in FIG. 17, processes except Step S1701 are the same as in the processing sequence shown in FIG. 11, and thus a detailed description thereof is omitted. Here, Step S1701 is described.

(Step S1701) The server notifying unit 1601 stores, in a memory region of a nonvolatile memory included therein, display information corresponding to the information displayed on the display unit 211 in Step S1103.

The following describes, with reference to FIG. 18, a processing sequence of the server notifying unit 1601 at the time when the information processing apparatus 100 is powered on.

(Step S1801) Though not shown, an operation such as pressing a power button by a user powers on the information processing apparatus 100, and the information processing apparatus 100 becomes ready to operate.

(Step S1802) Next, the server notifying unit 1601 starts communicating with the distribution server 901 so as to notify the distribution server 901 of the stored information. Various communications protocols such as a protocol unique to a communication carrier and a predetermined protocol over the Internet are available for the communication between the distribution server 901 and the information processing apparatus 100, but a detailed description thereof is omitted here.

(Step S1803) Then, when the server notifying unit 1601 succeeds in notifying the distribution server 901 of the stored display information, the server notifying unit 1601 terminates the process.

On the other hand, when the server notifying unit 1601 fails to notify the distribution server 901 of the display information, the server notifying unit 1601 proceeds to a process in Step S1804.

(Step S1804) When the server notifying unit 1601 fails to notify the distribution server 901 of the information, the server notifying unit 1601 stores again, in the nonvolatile memory included therein, the information displayed on the display unit 211. Subsequently, the server notifying unit 1601 proceeds to the process in Step S1802 so as to notify again the distribution server 901 of the display information.

It is to be noted that, here, after a predetermined time interval, the server notifying unit 1601 performs again the process in Step S1802 so as to notify the server of the display information.

The display information thus notified to the server is information which uniquely specifies the information displayed on the display unit 211. For instance, in the case of advertisement information, the display information is ID information capable of uniquely specifying an advertisement.

With the above, the information processing apparatus 100 successfully notifies the distribution server 901 of what kind of information has been displayed on the display unit 211 when the power has not been supplied to the display unit 211. Moreover, it is possible to determine in detail, at the distribution server 901, display information on a terminal in a period of time during which the information processing apparatus 100 is powered off, by notifying the distribution server 901 of the display information displayed on the display unit 211 having the electronic paper characteristic in the period of time during which the information processing apparatus 100 is powered off.

It is to be noted that although this embodiment has described the configuration of the information processing apparatus 100, the present invention is absolutely not limited to this embodiment. The embodiment can be modified without departing from a scope of the present invention. For instance, the present invention includes the following cases (modifications).

(1) The above embodiment has described the example the information processing apparatus 100 notifies the distribution server 901 of the display information when the information processing apparatus 100 is powered on, but such a timing is not limited to the condition. For example, the display information may be notified in a period of time during which the information processing apparatus 100 is powered off.

(2) The embodiment has described the example where when the information processing apparatus 100 fails to notify the distribution server 901 of the display information, the information processing apparatus 100 stores, in the nonvolatile memory in the server notifying unit 1601, the display information, and performs, for re-notification, a process of communication from the server notifying unit 1601 to the distribution server 901 after a predetermined time. However, a method of re-notifying the distribution server 901 is not limited to the above.

For instance, the distribution server 901 may be re-notified not after elapse of the predetermined time but with a timing immediately before the time when the information processing apparatus 100 is powered off. Furthermore, the above processing sequence may be a sequence in which the server notifying unit 1601 performs server communication processing for re-notification when the information processing apparatus 100 is powered on, in the case where the display information is notified to the distribution server 901 in the period of time during which the information processing apparatus 100 is powered off and in the case where the notification is unsuccessful.

As stated above, any method which allows the information processing apparatus 100 to notify the distribution server 901 of the information displayed on the display unit 211 in the period of time during which the information processing apparatus 100 is powered off may be employed.

(3) The embodiment has described the example where when the information displayed on the display unit 211 without power supply is, for example, the advertisement information, assuming that such information can be uniquely specified, the server notifying unit 1601 notifies the distribution server 901 of the display information which is like the ID information, but information to be notified is not limited to such information.

A method for directly transmitting the information displayed on the display unit 211 to the server may be employed. In other words, as long as information identifies the information displayed on the display unit 211 included in the information processing apparatus 100, the server notifying unit 1601 may notify the distribution server 901 of any such information.

### Embodiment 4

The following describes in detail Embodiment 4 of the present invention based on the drawings.

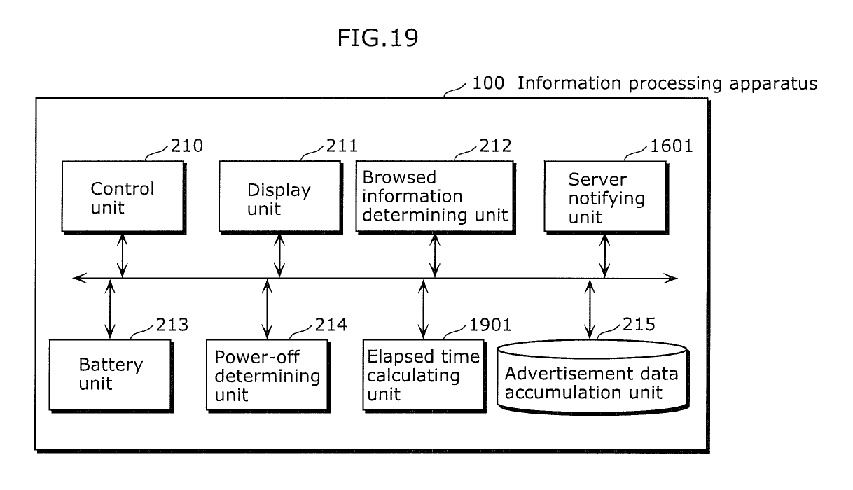

FIG. 19 is a block diagram showing a configuration of an information processing apparatus 100 according to this embodiment of the present invention. The information processing apparatus 100 includes a control unit 210, a display unit 211, a browsed information determining unit 212, a battery unit 213, a power-off determining unit 214, an advertisement data accumulation unit 215, a server notifying unit 1601, and an elapsed time calculating unit 1901.

A mobile digital apparatus such as a mobile telephone terminal, an electronic dictionary, and an electronic book reader is assumed as the information processing apparatus 100 according to this embodiment.

The control unit 210 controls various operations in the information processing apparatus 100, and controls various operations of the display unit 211, the browsed information determining unit 212, the battery unit 213, the power-off determining unit 214, the server notifying unit 1601, and the elapsed time calculating unit 1901.

The display unit 211 is the electronic paper having the memory characteristic. In the case of the above electrophoretic display scheme, the display unit 211 is a display configured through a method for controlling a display element such as a charged particle by applying a voltage between polar plates.

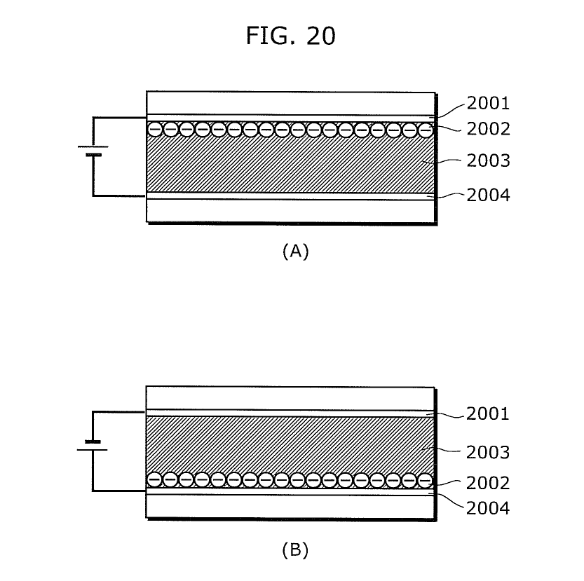

FIG. 20 is a diagram showing a specific electrophoretic display scheme. The electrophoretic display scheme forms a display by filing colored charged particles 2002 and insulation solution 2003 between a transparent electrode 2001 and an electrode 2004, applying a voltage between the electrodes, and electrophoresing the charged particles 2002.

Assuming that the charged particles take on a negative charge, when a positive voltage is applied, as shown in (A), the charged particles 2002 move to a surface side. Thus, a surface color becomes a color of the charged particles 2002.

On the other hand, when a negative voltage is applied, as shown in (B), the charged particles 2002 move away from the surface. Thus, the surface color becomes a color of the insulation solution 2003.

Furthermore, although the charged particles 2002 stay above the electrode due to electrostatic force or the like even after the application of the voltage is stopped, when charges are increasingly discharged along with the passage of time, the charged particles 2002 are not restricted by the transparent electrode 2001. Consequently, after elapse of a fixed period of time, a display on the electronic paper surface changes (e.g., the display becomes lighter or the like.)

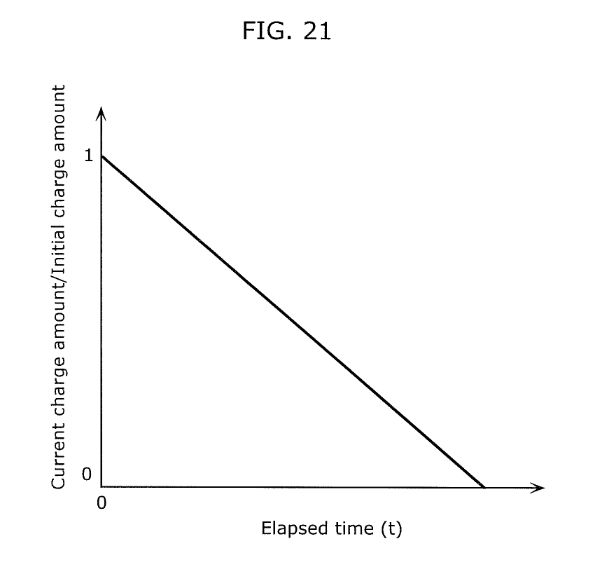

Moreover, the higher the voltage applied between the electrodes is, the greater a charge amount between the electrodes becomes. Accordingly, it is possible to calculate how long the voltage has not been applied between the electrodes, by comparing an initial difference in potential between pairs of the electrodes with a difference in residual potential between the same after elapse of a fixed period of time. FIG. 21 is a diagram showing a ratio of a current charge amount to an initial charge amount.

The elapsed time calculating unit 1901 holds information on an initial applied voltage between electrodes and base data which allows calculation of elapsed time from a difference in potential as shown in FIG. 21.

With this, the elapsed time calculating unit 1901 calculates, from the current difference in potential between the pairs of the electrodes, the elapsed time indicating how long the information such as the advertisement data has been displayed without the application of the voltage.

The server notifying unit 1601 notifies the server of the information (display information) which allows identification of the information displayed on the display unit 211 and the elapsed time calculated by the elapsed time calculating unit 1901.

The browsed information determining unit 212, the battery unit 213, and the power-off determining unit 214, which are elements other than the server notifying unit 1601 of the information processing apparatus 100, are the same as those in Embodiment 3, and thus a description thereof is omitted here.

The following describes, with reference to a flowchart, elapsed time calculation processing performed by the information processing apparatus 100 according to this embodiment.

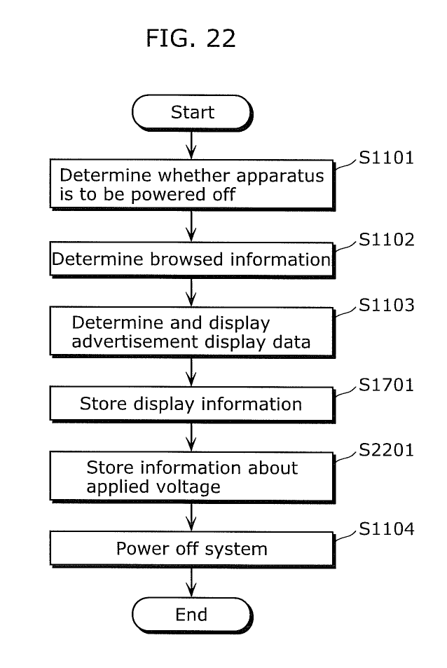

FIG. 22 is a flowchart showing a flow of display update control processing of a display unit, server notification control processing, and elapsed time calculation control processing when the information processing apparatus 100 is powered off.

Processes shown in FIG. 22 except a process in Step S2201 are the same as those shown in FIG. 17, and thus a detailed description thereof is omitted. Therefore, here, the process in Step S2201 is described.

(Step S2201) The elapsed time calculating unit 1901 stores, in the nonvolatile memory or the like, information about an applied voltage at the time when the data is displayed on the display unit 211.

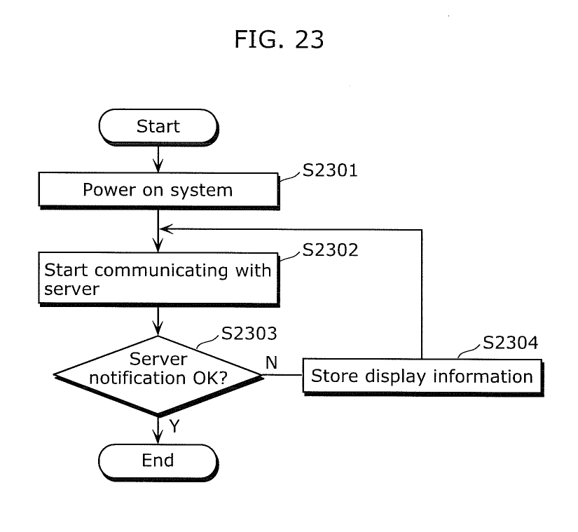

The following describes, with reference to FIG. 23, a processing flow of the server notifying unit 1601 at the time when the information processing apparatus 100 is powered on.

(Step S2301) Though not shown, an operation such as pressing a power button by the user powers on the information processing apparatus 100, and each of the processing units in the information processing apparatus 100 becomes ready to operate.

(Step S2302) Next, the server notifying unit 1601 starts communicating with the distribution server 901 so as to notify the distribution server 901 of the display information stored in the memory and the elapsed time calculated by the elapsed time calculating unit 1901.

Various communications protocols such as a protocol unique to a communication carrier and a predetermined protocol over the Internet are available for the communication between the distribution server 901 and the server notifying unit 1601, but a detailed description thereof is omitted here.

(Step S2303) Then, when the server notifying unit 1601 succeeds in notifying the distribution server 901 of the display information and the elapsed time, the information processing apparatus 100 terminates the process of the server notifying unit 1601.

On the other hand, when the notification to the distribution server 901 is unsuccessful, the server notifying unit 1601 proceeds to a process in Step S2304.

(Step S2304) When the notification of the information to the distribution server 901 is unsuccessful, the server notifying unit 1601 stores again, in the nonvolatile memory or the like held in the server notifying unit 1601, the display information displayed on the display unit 211 and the elapsed time calculated by the elapsed time calculating unit 1901.

Subsequently, the server notifying unit 1601 proceeds to the process in Step S2302 so as to notify again the distribution server 901 of the stored information. It is to be noted that, here, after a predetermined time interval, the server notifying unit 1601 performs again the process in Step S2302 so as to notify the distribution server 901 of the stored information.

In this manner, the information processing apparatus 100 according to this embodiment makes it possible to notify the distribution server 901 of how long and what kind of information has been displayed in a period of time during which the power is not supplied to the display unit 211.

Furthermore, the server notifying unit 1601 notifies the distribution server 901 of the information displayed on the display unit 211 and the elapsed time in the period of time during which the information processing apparatus 100 including the display unit 211 as the electronic paper is powered off, and thus it is possible to determine in detail, at the distribution server 901, the information displayed on the information processing apparatus 100.

It is to be noted that the present invention is not absolutely limited to the above embodiment. The embodiment can be modified without departing from a scope of the present invention. For instance, the present invention includes the following cases (modifications).

(1) The embodiment has described the example where the server notifying unit 1601 notifies the distribution server 901 of the information displayed on the display unit 211 and the elapsed time when the information processing apparatus 100 is powered on, but such a tinning is not limited to the embodiment.

The server notifying unit 1601 may notify the distribution server 901 of the information displayed on the display unit 211 in a period of time during which the information processing apparatus 100 is powered off, and may notify the distribution server 901 of the elapsed time when the information processing apparatus 100 is powered on.

Moreover, a tinning with which re-notification is performed when the notification to the distribution server 901 is unsuccessful is not limited to the embodiment. In other words, any method which allows the server notifying unit 1601 to notify the distribution server 901 of the information displayed on the display unit 211 and the elapsed time during which the information is displayed may be employed.

(2) The embodiment has described the example where the elapsed time calculating unit 1901 calculates, from the difference in residual potential of the display unit 211, the elapsed time, but a method for calculating an elapsed time is not limited to this.

For instance, it is considered that, after a time at which the information processing apparatus 100 is powered off is displayed (stored) in a predetermined format or the like on the display unit 211 when the information processing apparatus 100 is powered off, the information processing apparatus 100 obtains, by using a sensor included in the elapsed time calculating unit 1901, the power-off time from the display on the display unit 211, when the information processing apparatus 100 is powered on. Subsequently, the elapsed time calculating unit 1901 may determine the elapsed time based on the time information obtained by the sensor and a current time.

Furthermore, for example, the present invention includes the following case common to Embodiments 1 to 4.

(1) The embodiments have described the example where the information processing apparatus 100 is powered off, but when each processing unit or device has a power-saving mode, a change to the power-saving mode may be used instead of the power-off. Moreover, a mode in which a power is supplied to only necessary processing units or devices among the processing units or the devices may be used in stead of the power-off.

To put it differently, a process causing a change to a mode in which power consumption of the whole information processing apparatus 100 is reduced may be employed.

(2) Furthermore, the update of remaining battery amount displayed on the display unit 111 described in Embodiment 1 and the update of the main display contents on the display unit 111 described in Embodiments 2 to 4 may be combined for implementation.

(3) The embodiments have described the example where the display unit 111 or 211 includes the device having the memory characteristic such as the electronic paper, but the display unit 111 or 211 may be a device having a different characteristic.

Stated differently, as long as the information processing apparatus 100 updates screen information when a normal state is changed to a power-saving mode or power-off mode, the information processing apparatus 100 may include the display unit 111 or 211 having any characteristic.

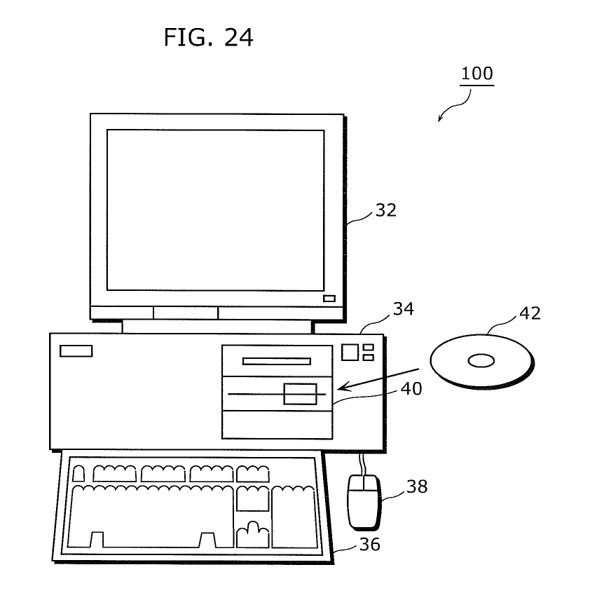

It is to be noted that the information processing apparatus 100 described in Embodiments 1 to 4 can be implemented by a computer. In FIG. 24, the information processing apparatus 100 includes a computer 34, a keyboard 36 and a mouse 38 for instructing the computer 34, a display 32 for displaying information such as computational results or the like of the computer 34, a CD-ROM device (Compact Disc-Read Only Memory) 40 for reading a program to be executed by the computer 34, and a communication modem (not shown).

The program which is processing performed by the information processing apparatus 100 is recorded on a CD-ROM 42 which is a computer-readable recording medium, and is read by the CD-ROM device 40. Alternatively, the program is read by the communication modem 52 through a computer network.

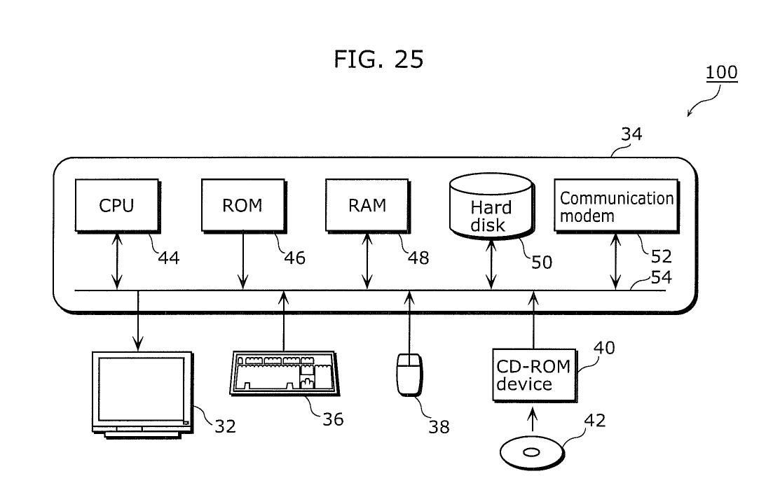

FIG. 25 is a block diagram showing a hardware configuration of a computer system which implements the information processing apparatus 100. The computer 34 includes a CPU (Central Processing Unit) 44, a ROM (Read Only Memory) 46, a RAM (Random Access Memory) 48, a hard disk 50, a communication modem 52, and a bus 54.

The CPU 44 executes a program read through the CD-ROM device 40 or the communication modem 52. The ROM 46 stores programs or data necessary for operations of the computer 34. The RAM 48 stores data such as parameters at the time of program execution. The hard disk 50 stores programs, data, and the like. The communication modem 52 performs communication with other computers through the computer network. The bus 54 reciprocally connects the CPU 44, the ROM 46, the RAM 48, the hard disk 50, the communication modem 52, the display 32, the keyboard 36, the mouse 38, and the CD-ROM device 40.

Moreover, part or all of the elements included in each of the apparatuses may be included in one system LSI (Large Scale Integration). The system LSI is a super-multifunctional LSI manufactured by integrating components into one chip, and is specifically a computer system including a microprocessor, a Rom, a RAM, and so on. The RAM stores a computer program. The micro processing unit operates according to the computer program, so that the system LSI fulfills its functions.

Furthermore, part or all of the elements included in each apparatus may be included in an IC card removable from each apparatus or in a stand alone module. The IC card or the module is a computer system including a micro processing unit, a ROM, a RAM, and so on. The IC card or the module may include the super-multifunctional LSI. The micro processing unit operates according to a computer program, so that the IC card or the module fulfills its functions. The IC card or the module may have tamper-resistance.

Moreover, the present invention may be any of the above methods. In addition, the present invention may be a computer program which causes a computer to execute these methods or a digital signal which is composed of the computer program.

Furthermore, in the present invention, the computer program or the digital signal may be recorded on a computer-readable recording medium such as a flexible disk, a hard disk, a CD-ROM, an MO, a DVD, a DVD-ROM, a DVD-RAM, a BD (Blu-ray Disc™), a USB memory, a memory card such as an SD card, and a semiconductor memory. In addition, the digital signal may be recorded on these recording media.

Moreover, in the present invention, the computer program or the digital signal may be transmitted through an electronic communication line, a wireless or wired communication line, a network represented by the Internet, data broadcasting, and the like.

Furthermore, the present invention may be a computer system including a micro processing unit and a memory. The memory may store the computer program, and the micro processing unit may operate according to the computer program.

Moreover, the present invention may execute the computer program or the digital signal in another independent computer system by recording the computer program or the digital signal on the recording medium and transmitting the recorded computer program or digital signal or by transmitting the computer program or the digital signal through the network and the like.

Furthermore, the above embodiments and the above modifications may be combined respectively.

It should be considered that the embodiments disclosed herein are exemplary in all respects and not restrictive at all. It is intended that the scope of the present invention is indicated by not the above description of the embodiments but claims, and that any change that has equivalent meaning as and fall within the claims are included.

### INDUSTRIAL APPLICABILITY

The information processing apparatus and the control method thereof according to the present invention make it possible to (i) combine the thrifty power consumption with the up-to-dateness of display information by updating the information displayed on the display device including the electronic paper to the appropriate information in the period of time during which the information processing apparatus is powered off, and (ii) provide the user-friendly user interface.

### REFERENCE SIGNS LIST

32 Display

34 Computer

36 Keyboard

38 Mouse

40 CD-ROM device

42 CD-ROM

44 CPU

46 ROM

48 RAM

50 Hard disk

52 Communication modem

54 Bus

100 Information processing apparatus

110, 210 Control unit

111, 211 Display unit

112 Remaining amount data generating unit

113 Remaining amount determining unit

114, 213 Battery unit

115 Timer unit

116, 214 Power-off determining unit

117 Management table

212 Browsed information determining unit

215 Advertisement data accumulation unit

901 Distribution server

902 Communication network

1601 Server notifying unit

1901 Elapsed time calculating unit

2001 Transparent electrode

2002 Charged particle

2003 Insulation solution

2004 Electrode

1-2. (canceled)

3. An information processing apparatus which processes and displays information, said information processing apparatus comprising:
a display unit having a memory characteristic for continuously holding a display content without power supply;
a power-off determining unit configured to specify an amount of power to be supplied to said information processing apparatus that is equal to or less than a predetermined amount; and
a control unit configured to display predetermined data on said display unit and set the amount of the power to be supplied to said information processing apparatus to be equal to or less than the predetermined amount, when said power-off determining unit specifies the amount of the power supplied to said information processing apparatus that is equal to or less than the predetermined amount.

4. (canceled)

5. The information processing apparatus according to claim 3,
wherein the predetermined data is information about an advertisement.

6. The information processing apparatus according to claim 5, further comprising
a server notifying unit configured to notify a server of information via a communication network,
wherein said control unit is configured to notify, through said server notifying unit, the server of information uniquely specifying the predetermined data displayed on said display unit, when said power-off determining unit specifies the amount of the power to be supplied to said information processing apparatus that is equal to or less than the predetermined amount.

7. The information processing apparatus according to claim 6, further comprising
an elapsed time calculating unit configured to calculate a period of time during which power is not supplied, from a difference between a display at the time when power is supplied to said display unit and a display at the time when power is not supplied to said display unit,
wherein said control unit is configured to notify, through said server notifying unit, the server of a period of time during which power is not supplied and which is determined by said elapsed time calculating unit.

8. The information processing apparatus according to claim 5, further comprising
a browsed information determining unit configured to accumulate and determine browsed information of a user; and
an advertisement data accumulation unit configured to accumulate advertisement data,
wherein said control unit is configured to select the advertisement data accumulated in said advertisement data accumulation unit, based on a result of the determination, which is made by said browsed information determining unit, of the browsed information of the user according to a predetermined evaluation criterion.

9. The information processing apparatus according to claim 8,
wherein the predetermined evaluation criterion is a value based on the number of browses made by the user.

10. The information processing apparatus according to claim 8,
wherein the predetermined evaluation criterion is a value based on a total browsing time of the user.

11. The information processing apparatus according to claim 8,
wherein said browsed information determining unit is configured to make the determination based on the information displayed on said display unit, and
said control unit is configured to select the advertisement data accumulated in said advertisement data accumulation unit, based on the result of the determination.

12. The information processing apparatus according to claim 3,
wherein the predetermined data is information indicating whether or not the user has used or browsed various types of content stored in said information processing apparatus.

13. The information processing apparatus according to claim 3,
wherein the predetermined data is an information list of various types of content data stored in said information processing apparatus.

14. The information processing apparatus according to claim 3,
wherein the predetermined data is data for erasing part or all of data displayed on said display unit.

15. (canceled)

16. A control method performed by an information processing apparatus which processes and displays information, said control method comprising:
specifying an amount of power to be supplied to the information processing apparatus that is equal to or less than a predetermined amount; and
notifying, through various wired or wireless networks, a server of information specifying data displayed on a display unit and a display time of the data displayed on the display unit, when the amount of the power to be supplied to the information processing apparatus that is equal to or less than a predetermined amount is specified, the information processing apparatus displaying various types of information on the display unit.
